(19) United States
(12) Patent Application Publication
(10) Pub. No.: US 2005/0143137 A1
(43) Pub. Date: Jun. 30, 2005

(54) Terminal apparatus

(75) Inventors: Keigo Matsunaga, Kawasaki (JP); Takahiro Yamazaki, Kawasaki (JP); Kenichi Izumi, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 10/832,280

(22) Filed: Apr. 27, 2004

(30) Foreign Application Priority Data
Dec. 25, 2003 (JP) 2003-429534

(51) Int. Cl. G09G 5/00

(52) U.S. Cl. 455/566

(57) ABSTRACT

A terminal apparatus is provided that has a first and a second display units; and a control unit which controls display contents of the first and the second display units respectively. The control unit displays, on the second display unit, status information as well as an operation key associated with the display contents displayed on the first display unit. The control unit changes the display contents displayed on the first display unit in response to an input with the operation key.

### BACKGROUND OF THE INVENTION

1. Field of the Invention

The present invention relates to a terminal apparatus which has at least two (2) display units.

2. Description of the Related Art

Currently, for a portable telephone (including PHS (Personal Handyphone System)), a display unit such as a liquid-crystal screen is indispensable. This is because it acts as an interface when a user conducts various operations, such as making a telephone call (including videophone), reading a schedule book or an address book to check details, calling a menu for various settings, reading and writing a mail, browsing Web contents, viewing still images and moving images and others. Considering visibility and usability, it is desirable to use the display unit as broadly as possible for above-mentioned operations.

But, on the conventional display unit of the portable telephone, so-called status information such as a remaining level of a battery, an radio wave receiving condition, a date, an icon for indicating a setting status of the manner mode (a mode which notifies of an incoming call by means other than sound (vibration, light emitting and others)), an icon for indicating a setting status of an alarm, an icon for indicating presence of unanswered incoming calls (phone call, e-mail, facsimile and others), an icon for indicating presence of voice messages (messages left on an answering machine) and an icon for indicating being in the internet connection status, or guidance information which indicates functions allocated to input means (buttons, keys and others) of the portable telephone is displayed such that upper and lower zones of a liquid-crystal screen are occupied.

Therefore, as a method for enlarging the display area of the display unit, in Japanese Patent Application Laid-Open Pub. No. 2002-369252, in a folding-type portable telephone having two (2) display units (main screen and sub-screen), by displaying the guidance information on the sub-screen which can be visually recognized regardless of being in a folded state, a main screen is enlarged because the guidance information which is traditionally displayed is moved to the sub-screen.

However, in conventional examples, the status information is still displayed on the (main) display unit, and it has not yet achieved to use the whole display unit to read and write an e-mail, browse Web contents or view still images and moving images, and room for improvement has been left.

### SUMMARY OF THE INVENTION

It is therefore the object of the present invention to provide a terminal apparatus and display method which ensures that, when viewing texts of e-mails and Web contents or viewing and shooting still images and moving images, these operations can be performed using a whole (main) display unit.

In order to achieve the above object, according to the major aspect of the present invention there is provided a terminal apparatus having a first and a second display units; and a control unit which controls display contents of the first and the second display units respectively, wherein the control unit displays, on the second display unit, status information as well as an operation key associated with the display contents displayed on the first display unit and changes the display contents displayed on the first display unit in response to an input with the operation key.

Preferably, the status information displayed on the second display is visually recognizable as long as the power is on. It is preferred that if there is an concomitant display which is displayed concomitantly to the display contents, the control unit display the concomitant display on the second display unit. The operation key may be a touch panel. The status information may include any one selected from a group having a remaining level of a battery, an radio wave receiving condition, a date, an icon indicating a setting status of the manner mode, an icon indicating an alarm setting status, an icon indicating presence of unanswered incoming calls, an icon indicating presence of messages left on an answering machine and an icon indicative of being in the Internet connection status.

Moreover, the terminal apparatus may further have a joint unit for joining a first housing where the first display unit is disposed and a second housing where the second display is disposed each other, wherein the first housing and the second housing is foldably joined together via the joint unit and the status information is displayed on the second display unit such that it can be visually recognized in a folded state.

According to the present invention, status information or guidance information is not displayed on a first display unit (main screen) to enable effective utilization of whole screen, and a layout of the screen becomes more clear than the case that such information is displayed, and visibility is improved. The display area of the first display unit is further enlarged by displaying an concomitant display on a second display unit (sub-screen), which is displayed concomitantly to the display contents of the first display unit.

For example, in the case of using videophone, traditionally, an image shot by a terminal of the other calling party (face of the other party) and an image shot by own terminal (face of oneself) are displayed on one (1) screen, but by displaying the face of the other party on the main screen and the face of oneself on the sub-screen, it is possible to feel like talking face to face, and the sense of reality is enhanced. Also, by using the sub-screen for previewing an image file attached to an e-mail, the main screen can continue displaying the body text, and it is possible to read the body text while identifying the image file, without the display area of the body text being occupied by the attached image file. Therefore, a user can make the most of e-mails, Web contents, moving images, still images and others without being bothered by status information and guidance information.

Since operation keys are displayed on a touch panel provided on the second display unit (sub-screen) depending on the display contents of the first display unit, a button layout is organized, and since the operation keys displayed on the sub-screen act as input means, it is not necessary to display the guidance information. Further, by watching the second display unit, the user can identify the status information. For this status information, if the concomitant display is displayed on the second display unit, the status information is displayed in a layered style, and the status information can also be identified in this case.

### BRIEF DESCRIPTION OF THE DRAWINGS

The above and other objects, aspects, features and advantages of the present invention will become more apparent from the following detailed description when taken in conjunction with the accompanying drawings, in which:

FIGS. 1A to 1D are outside views of terminal apparatuses in an embodiment of the present invention, FIG. 1A illustrating a flip-type portable telephone when a flip is in a closed state, FIG. 1B illustrating the flip-type portable telephone when a flip is in an opened state, FIG. 1C illustrating a folding-type potable telephone which is released from a folded state, or is in an opened state, and FIG. 1D illustrating the folding-type potable telephone in the folded state;

FIGS. 2A to 2D are diagrams illustrating specific examples of the display contents of each display unit, FIG. 2A showing a first display example of a first display unit, FIG. 2B showing second display example of the first display unit, FIG. 2C showing a display example of a second display unit, and FIG. 2D showing a display example of status information displayed on the second display unit;

FIG. 3 is a block diagram illustrating a configuration example of the portable telephone of the present embodiment;

FIG. 4 is a flowchart showing the example of the control operation of display contents on each screen of the portable telephone of the present embodiment;

FIG. 5 is a flowchart describing a specific example of the control operation of the display contents on each screen of the portable telephone of the present embodiment;

FIGS. 6A to 6C are specific examples of the transition of the display contents on each screen;

FIGS. 7A to 7D are diagrams describing specific examples of concomitant displays), FIG. 7A showing an example at the time of using videophone, FIG. 7B showing an example at the time of viewing an e-mail, FIG. 7C showing an example at the time of viewing a still image, and FIG. 7D showing an example at the time of playing a game; and

FIGS. 8A to FIG. 8E are outside views of terminal apparatuses of another embodiment of the present invention.

### DESCRIPTION OF THE PREFERRED EMBODIMENTS

Embodiments of the present invention will now be described with reference to the drawings. It is to be noted however that the technical scope of the present invention is not limited to these embodiments but covers the invention as defined in claims and equivalents thereof.

Hereinafter, the case of a folding-type portable telephone (including PHS (Personal Handyphone System)) is described as an example of a terminal apparatus of the present invention.

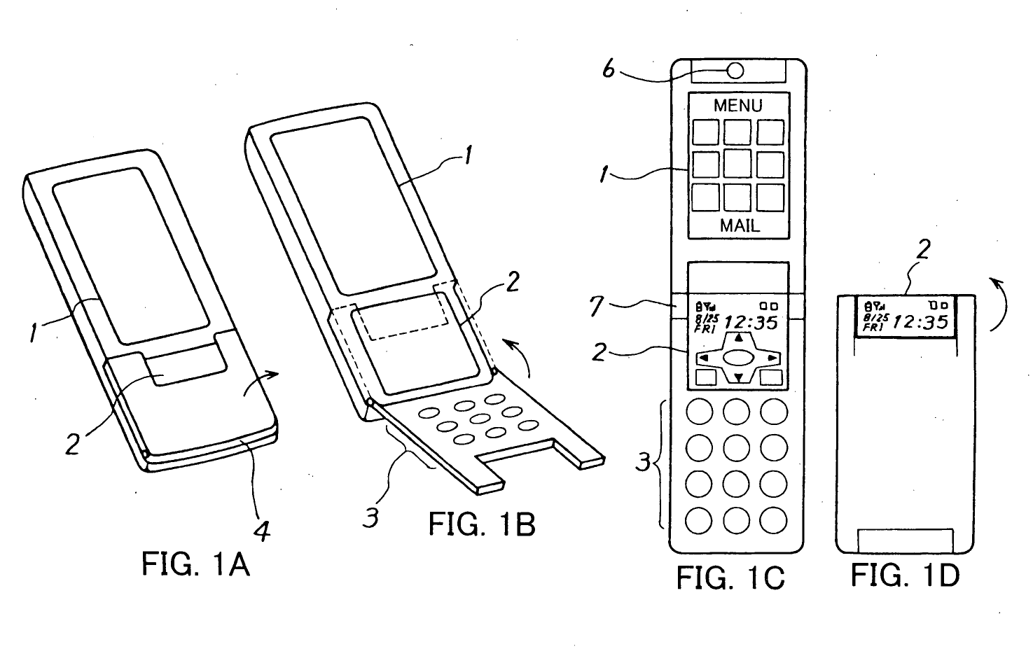

FIGS. 1A to 1D are outside views of portable telephones (including PHS) in an embodiment of the present invention; FIG. 1A and FIG. 1B illustrate a flip-type portable telephone; and FIGS. 1C and 1D illustrate a folding-type portable telephone. FIG. 1A illustrates the flip-type portable telephone when a flip 4 is in a closed state. In this state, a main screen 1 and a portion of a sub-screen 2 can be visually recognized. On the main screen 1, a menu for operating the portable telephone is displayed, and contents corresponding to the selected menu are displayed. As examples of the contents, e-mails, Web contents, still images, moving images, setting modification screen of the portable telephone and others can be cited.

When the flip is in a closed state, a portion of the sub-screen 2 can also be visually recognized. On the portion which can be visually recognized, so-called status information, such as a remaining level of a battery, an radio wave receiving condition, a date, an icon for indicating a setting status of the manner mode (a mode which notifies of an incoming call by means other than sound (vibration, light emitting and others)), an icon for indicating a setting status of an alarm, an icon for indicating presence of unanswered incoming calls (phone call, e-mail, facsimile and others), an icon for indicating presence of voice messages (messages left on an answering machine) and an icon for indicating being in the internet connection status, is displayed.

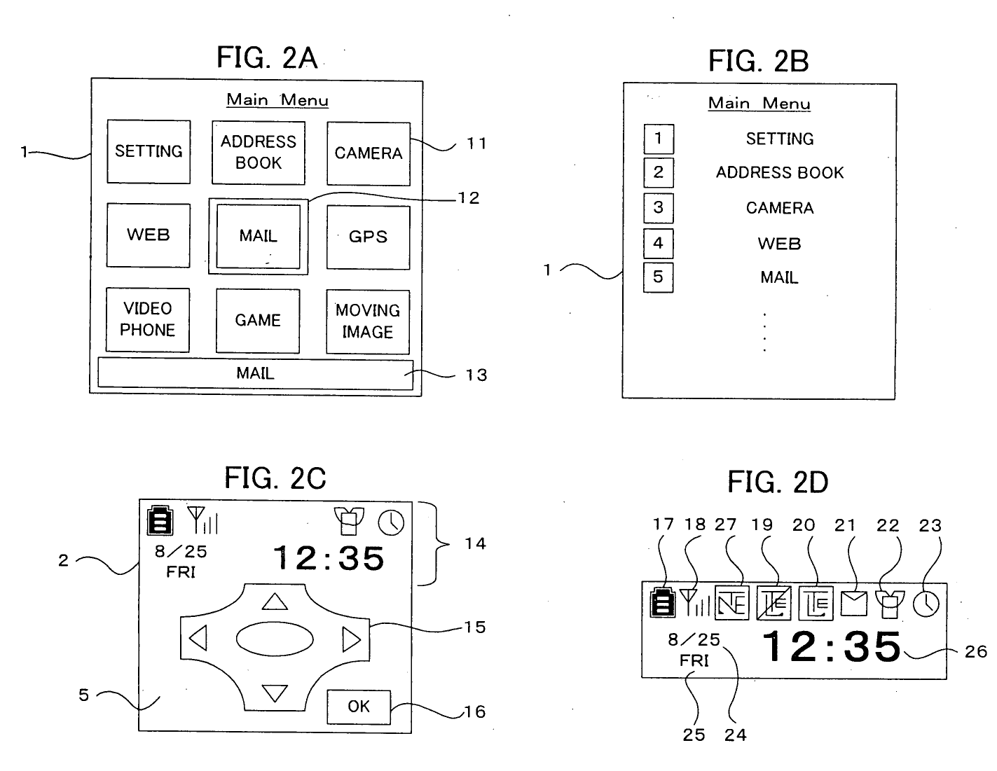

FIG. 1B is a diagram illustrating a state that the flip 4 is opened by moved to a direction of an arrow of FIG. 1A. When the flip 4 is in the opened state, whole of the sub-screen 2 covered by the flip 4 can be identified. The sub-screen 2 displays the status information and operation keys and is a touch panel. The operation keys are varied depending on the display contents of the main screen 1. The status information and operation keys displayed on the sub-screen are specifically described in FIG. 2. The flip can be closed by moved to a direction of an arrow of FIG. 1B.

Therefore, a user who utilizes the portable telephone of FIG. 1A and FIG. 1B can input instructions to the portable telephone by touching the operation keys which are varied depending on the display contents of the main screen 1. The status information can be identified regardless of opened or closed states of the flip.

When the flip 4 is in the opened state, input buttons 3 disposed on the flip 4 are revealed. The input buttons 3 are used for inputting details of the instruction from the user when selecting a portable telephone operation menu and when inputting telephone numbers or e-mail addresses at the time of transmission, and there are a power button (double as a call ending button), a call starting button, dial number buttons, a wrong input canceling button (clear button) and others. In addition, the portable telephone of the present embodiment is also provided with a speaker (not shown), a camera (not shown) which takes images from the own terminal (face of oneself) when videophone is used, a microphone (not shown), a communication antenna (not shown) and a photography camera (not shown) and can perform voice-only calls and calls based on the videophone function using voices and images, reception of the Web contents, transmission and reception of e-mails, shooting and viewing of still images or moving images and others.

FIG. 1C is a diagram illustrating a folding-type potable telephone which is released from the folded state, or is in the opened state. As shown in FIG. 1C, a main screen 1 and a sub-screen 2 can be visually recognized in the opened state of the portable telephone. On the main screen 1 of FIG. 1C, a menu for operating the portable telephone is displayed, and contents corresponding to the selected menu are displayed. As examples of the contents, e-mails, Web contents, still images, moving images, setting modification screen of the portable telephone and others can be cited, and in FIG. 1C, the portable telephone operation menu is displayed as an example on the main screen 1.

The sub-screen 2 displays the status information and operation keys and is a touch panel. The operation keys are varied depending on the display contents of the main screen 1. Therefore, a user can input instructions to the portable telephone by touching the operation keys which are varied depending on the display contents of the main screen 1. In FIG. 1C, a direction select key (cross-shaped key) and two processing keys (rectangular keys) are displayed on the sub-screen 2 as examples.

In addition, the portable telephone of the present embodiment is also provided with input buttons 3 which are used for inputting details of the instruction from the user when selecting the portable telephone operation menu and when inputting telephone numbers or e-mail addresses at the time of transmission, a speaker (not shown), a camera 6 which takes images from the own terminal (face of oneself) when videophone is used, a microphone (not shown), a communication antenna (not shown) and a photography camera (not shown) and can perform voice-only calls and calls based on the videophone function using voices and images, reception of the Web contents, transmission and reception of e-mails, shooting and viewing of still images or moving images and others. The input buttons 3 include a power button (double as a call ending button), a call starting button, dial number buttons, a wrong input canceling button (clear button) and others.

FIG. 1D is a diagram illustrating the folded state. A first housing having the main screen and a second housing having the sub-screen are jointed via a hinge 7, and the folding can be achieved by rotating to a direction of a arrow of FIG. 1D though the hinge 7. As shown in FIG. 1D, the status information displayed on the portion of the sub-screen 2 which can be visually recognized is identified even in the closed state.

As shown in each diagram included in FIGS. 1A to 1D, in the present embodiment, since the status information is displayed on the sub-screen 2 and, because the sub-screen 2 is the touch panel, since the operation key displayed on the sub-screen 2 acts as the input means, it is not necessary to display the guidance information. Therefore, the whole main screen can be used for displaying the contents, and a layout of the screen becomes more clear than the case that such information (status information or guidance information) is displayed, and visibility is improved. The status information is displayed on the position of the sub-screen which can be always visually recognized and will not be dependent on the states of the flip or whether it is in the folded state or not.

In the description below, the folding-type portable telephone (including PHS) shown in FIG. 1C and FIG. 1D is used as an example of the terminal apparatus.

FIGS. 2A to 2D are diagrams illustrating specific examples of the display contents of each display unit (main screen, sub-screen), and FIG. 2A is a display example of the portable telephone operation menu displayed on the main screen 1. In FIG. 2A, as the menu, nine (9) items are displayed as icons 11, and a selected object are switched by operating an operation key displayed on the sub-screen 2, which is described layer (see FIG. 2C, for example a cross-shaped key 15), to move a cursor 12 displayed on the main screen 1. An area 13 displays which icon 12 is currently selected by the cursor 12, and in FIG. 2A, it is understood that a “mail” in the middle is the selected object. The menu is selected by the user moving the cursor 12 to the icon of the selected object to decide. FIG. 2B is another display example of the portable telephone operation menu displayed on the main screen 1. In FIG. 2B, each item is displayed in a list form, and the menu is selected by the user selecting a number at the head.

FIG. 2C is a display example of the sub-screen 2. On the sub-screen 2, status information 14 is displayed, and a remaining level of a battery and others can be identified. Details of the status information 14 are described in FIG. 2D. In addition, on the sub-screen 2 of FIG. 2C, a direction select key (cross-shaped key) 15 and a “OK” key 16 are displayed as operation keys. For example, the cross-shaped key 15 is used for moving the cursor shown in FIG. 2A, and the “OK” key 16 is used for deciding the icon of the selected object. The sub-screen 2 is a touch panel 5, and input of instructions are performed by touching the operation keys.

FIG. 2D is a display example when a display portion of the status information is extracted. A remaining level of a battery 17, an radio wave receiving condition 18, an icon for indicating being in the internet connection status 27, an icon for indicating presence of unanswered incoming telephone calls 19, an icon for indicating presence of voice messages (messages left on an answering machine) 20, an icon for indicating presence of incoming mails 21, an icon for indicating a setting status of the manner mode (a mode which notifies of an incoming call by means other than sound (vibration, light emitting and others)) 22, an icon for indicating a setting status of an alarm 23, a date 24, a day of the week 25 and a time 26 are displayed depending on the states of the portable telephone. In addition, an icon for indicating presence of incoming facsimiles may exist.

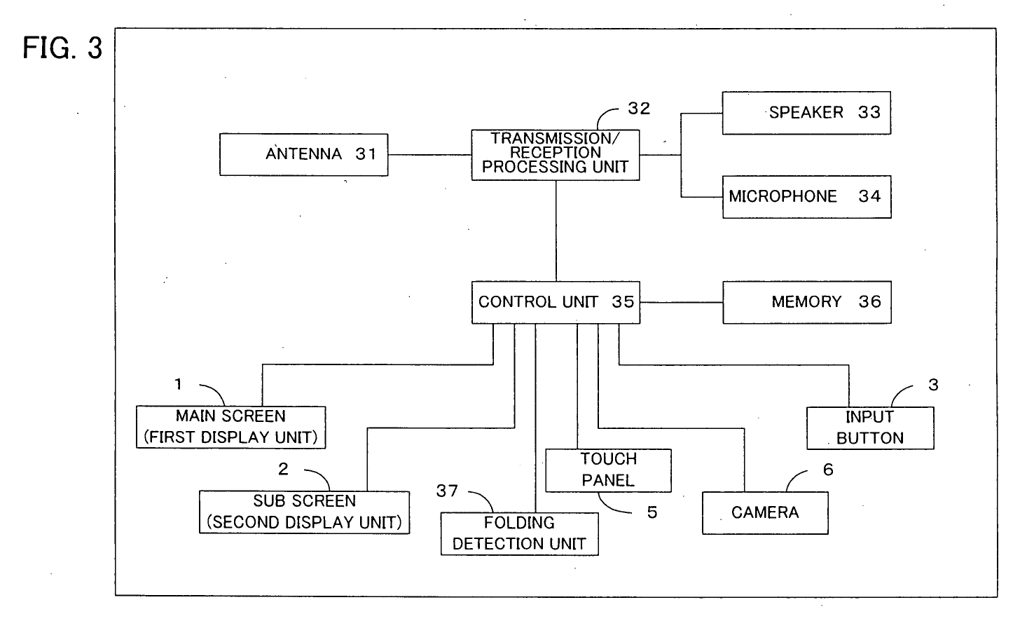

FIG. 3 is a block diagram illustrating a configuration example of the portable telephone (including PHS) of the present embodiment. The portable telephone of the present embodiment has an antenna 31, a transmission and reception processing unit 32, a speaker 33, a microphone 34, control unit 35, a memory 36, the main screen (first display unit) 1, the sub-screen (second display unit) 2, a folding detection unit 37, the touch panel (5), the camera 6 and the input buttons 3.

The antenna 31 performs transmission and reception of radio waves with a base station. The transmission and reception processing unit 32 modulates voices for transmission input through the microphone 34 and data input via the touch panel 5 or the input buttons 3 to output to the antenna 31 and demodulates radio waves received from the antenna 31 to output to the speaker 33.

The control unit 35 includes CPU, which controls the transmission and reception processing unit 32, the main screen 1, the sub-screen 2, the folding detection unit 37, the touch panel 5, the camera 6, the input buttons 3 and the memory 36, and ROM, which stores information necessary for control. The main screen 1 and the sub-screen 2 are, for example, display units such as a liquid-crystal display and display various information on the portable telephone. The memory 36 stores operation data used by the control unit 35, incoming-call information for displaying the incoming-call history and others. The folding detection unit 37 is means for detecting whether it is in the folded state or the opened state as well as changes of the states, utilizing a light sensor, magnets, angles of the hinge, or others. The display contents on the main screen 1 and the sub-screen 2 are controlled by the control unit 35, and an example of the control operation is then described.

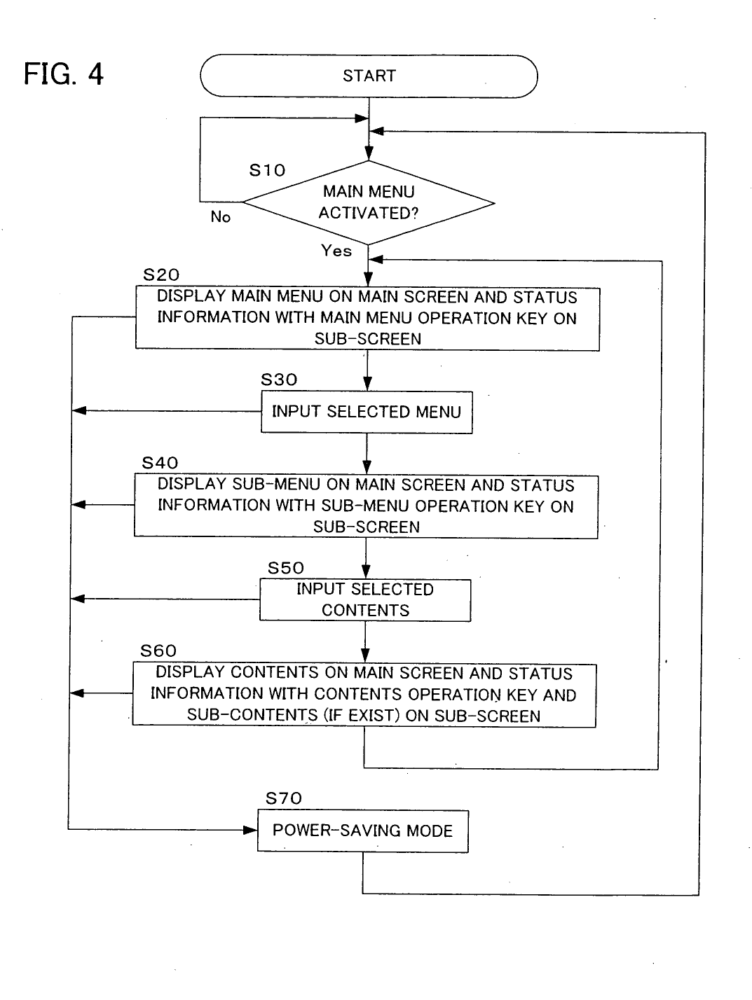

FIG. 4 is a flowchart describing the example of the control operation of the display contents on each screen of the portable telephone (including PHS) of the present embodiment. First, the control unit 35 determines whether a main menu is activated or not (S10). The main menu is a menu displayed at the start when the portable telephone menu is called, and items thereof are stored in the ROM of the control unit 35. In step S10, for example if the folding detection unit 37 detects that the folded state is changed to the opened state, the determination becomes positive. Also, when a main menu calling button is prepared as the input button and if it is detected that the button is pushed, the determination may become positive. Further, when a main menu calling key is displayed on the sub-screen 2 as the operation key and if it is detected that the key is touched, the determination may become positive.

If the determination in step S10 is positive (S10 Yes), the control unit 35 respectively displays the main menu on the main screen 1 and the status information 14 with the main menu operation key (see FIG. 2C, for example the cross-shaped key 15) on the sub-screen 2 (S20). For example, on the main screen 1, the display contents shown in FIG. 2A and FIG. 2B are displayed. On the sub-screen 2, the display contents shown in FIG. 2C are displayed. If the determination in step S10 is negative (S10 No), it waits until activation of the main menu.

The user then selects an item from the menu and operates the touch panel or others to input it. When the selected item is input via the touch panel 5 or others (S30), the control unit 35 respectively displays a sub-menu for that item on the main screen 1 and the status information 14 wiht the sub-menu operation key (see FIG. 2C, for example the cross-shaped key 15) on the sub-screen 2 (S40).

The user then selects contents from the sub-menu and operates the touch panel or others to input it. When the selected contents are input via the touch panel 5 or others (S50), the control unit 35 respectively displays that contents on the main screen 1 and the status information 14 and the contents operation key (see FIG. 2C, for example the cross-shaped key 15) on the sub-screen 2 (S60). In step S60, for example, main screen 1 displays contents list corresponding to each sub menu in the same display format as FIG. 2A or FIG. 2B and sub screen 2 displays the display contents shown in FIG. 2C. In step S60, if there are sub-contents (the concomitant displays) which are displayed concomitantly to the contents, the sub-contents may be displayed on the sub-screen 2. As the sub-contents, contents of image files attached to mails, a face of oneself at the time of using videophone and others are available.

In each step (S10, S20, S30, S40, S50 and S60), if an operation is not performed for predefined time, the portable telephone can make the transition to a power-saving mode which reduces the display contents for reducing electricity consumption (S70). For example, in each display unit (main screen 1 and sub-screen 2), the backlight for the liquid-crystal screen is turned off; the display contents are switched to predefined stand-by screen; or the display contents are switched to the plain-screen display leaving the status information. If the activation of the main menu is performed again, the operation is resumed from step S10.

In FIG. 4, the main menu and the sub-menu are passed through until the contents are selected, but in some cases, the contents are selected directly from the main menu. In these cases, steps S30 and S40 are omitted. On the contrary, if a plurality of menus further exists below the sub-menu, step S30 and step S40 will be repeated for multiple times until the contents is selected.

In this way, by the display control of FIG. 4, if the terminal is powered on, the status information 14 is displayed on the sub-screen 2, and the user can identify the states of the portable telephone. The operation key (see FIG. 2C, for example a cross-shaped key 15) displayed on the sub-screen 2 is changed accordingly depending on the display contents of the main screen 1, and since various operations can be performed without allocating special roles to the input buttons 3, a layout of the input buttons 3 can be made clear.

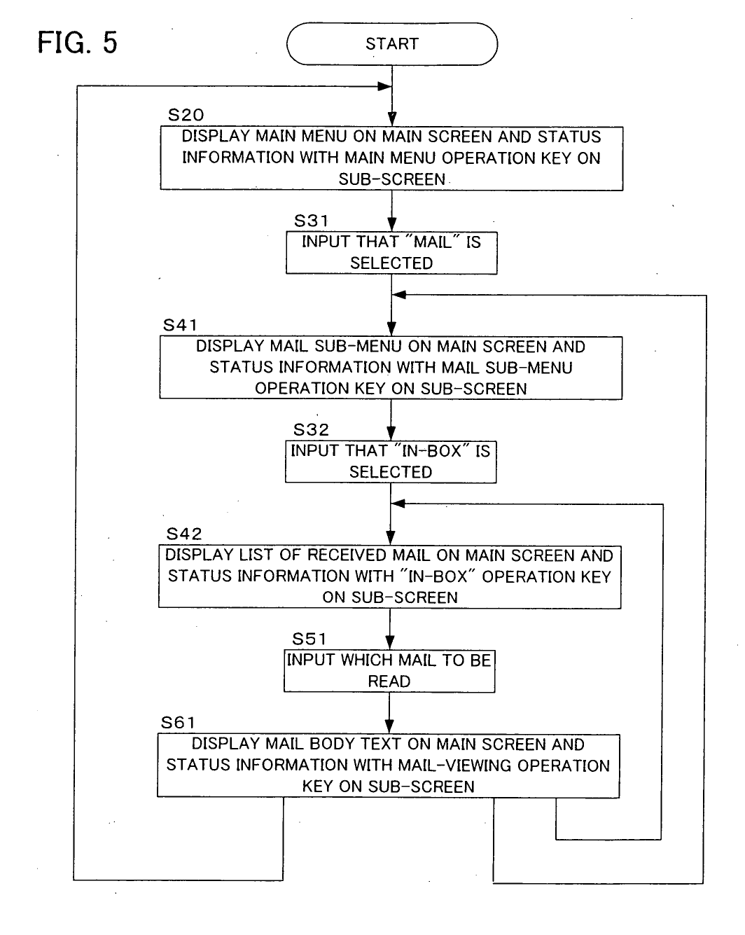

A more specific example is then described along with the display contents of each display, using FIG. 5 to FIG. 7. As the specific example, described is the case that “mail” is selected from the main menu to read an e-mail.

FIG. 5 is a flowchart describing the case that the “mail” is selected from the main menu to read an e-mail. In this description, it is assumed that the activation of the main menu (S10 Yes of FIG. 4) is already done.

The control unit 35 respectively displays the main menu on the main screen 1 and the status information 14 and the main menu operation keys on the sub-screen 2 (S20). The main menu displayed on the main screen 1 is shown in, for example, FIG. 2A of FIG. 2B. On the sub-screen 2, the status information and the main menu operation keys shown in, for example, FIG. 2C are displayed.

The user then selects the “mail” from the menu and operates the touch panel or others to input it (S31). For example, by operating the cross-shaped key 15 shown in FIG. 2C to move the cursor 12 to the “mail” and touching the “OK” key 16 of FIG. 2C, the “mail” is considered to be selected. In response to the input that the “mail” is selected, the control unit 35 respectively displays a sub-menu for the “mail” on the main screen 1 and the status information and the sub-menu operation keys on the sub-screen 2 (S41).

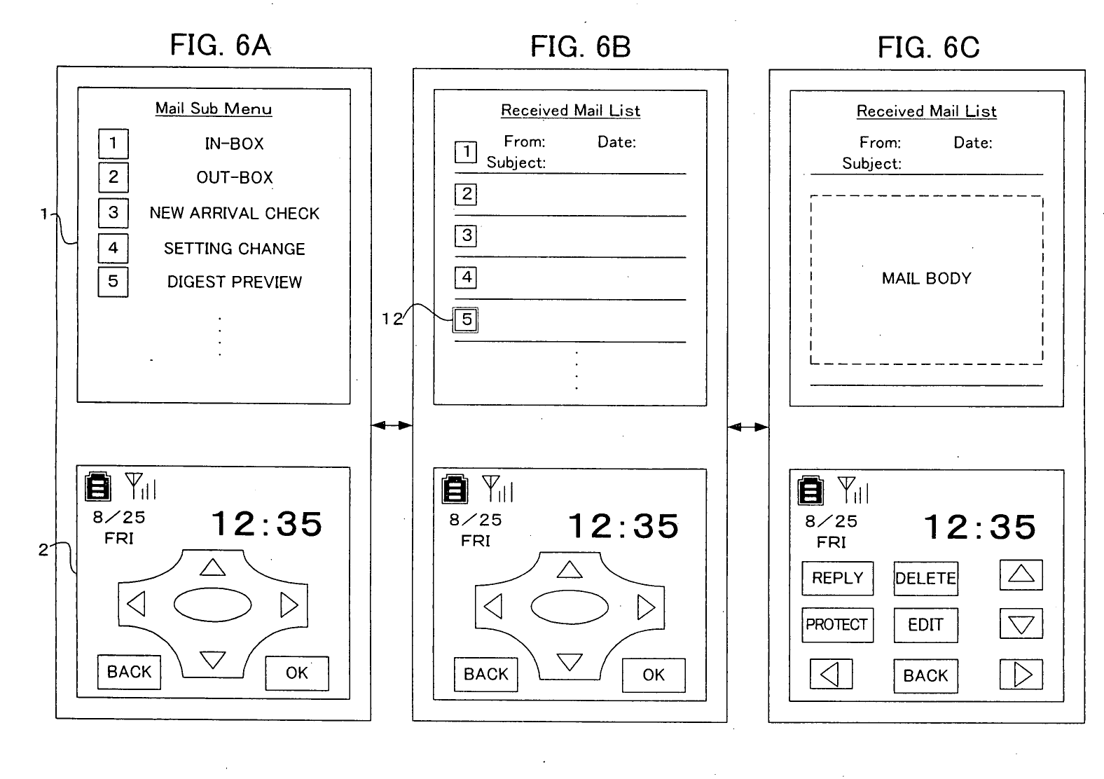

FIGS. 6A to 6C are display examples of the mail sub-menu displayed on the main screen 1 and the status information and the operation keys on the sub-screen 2. “In-box” is a menu selected when reading received e-mails. “Out-box” is a menu selected when identifying sent e-mails. “New arrival check” is a menu selected when manually obtaining new arrival of mails from a mail server. “Setting change” is a menu selected when modifying the setting for e-mails. “Digest preview” is a menu selected when previewing image files attached to e-mails all together. Other sub-menus may be set. If these can not be fit into one (1) screen, scrolling display is performed. On the sub-screen 2 of FIG. 2, a “back” key is displayed along with the cross-shaped key and the “OK” key. The “back” key makes displays of the main screen 1 go back to the state immediately before that.

The “in-box” is selected here (S32). The selection of step S32 is performed by use of the cross-shaped key and the “OK” key as is the case with the selection of step S31. In response to the input that the “in-box” is selected, the control unit 35 respectively displays a list of received mails on the main screen 1 as a sub-menu associated to the “in-box” and the status information and sub-menu operation keys for “in-box” on the sub-screen 2 (S42).

FIG. 6B is a display example of the list of received mails displayed on the main screen 1 and the status information and sub-menu operation keys displayed on the sub-screen 2. As header information of each mail of the list, a sender (From), a date (Date) and a title (Subject) are displayed. On the sub-screen 2 of FIG. 6B, the “back” key is displayed along with the cross-shaped key and the “OK” key as is the case with FIG. 6A.

The user then selects an e-mail that the user wants to read from the list of the received mail (this is considered as contents) and operates the touch panel or others to input it (S51). As the selection of step S51, a number associated with each e-mail may be identified by the input buttons 3, or the cursor may be moved to decide as is the case with step S31.

When the selecting information of the e-mail that the user wants to read is input via the touch panel 5 or others, the control unit 35 respectively displays body texts of the mail on the main screen 1 and the status information 14 and mail-viewing operation keys on the sub-screen 2 (S61).

FIG. 6C is a display example of the body texts of the selected e-mail displayed on the main screen 1 and the status information 14 and the mail-viewing operation keys on the sub-screen 2. On the main screen 1 of FIG. 6C, the body texts of the mail is displayed, along with the header information of the mail, which is a sender (From), a date (Date) and a title (Subject). On the sub-screen 2 of FIG. 6C, arrow keys when the previous cross-section key is disassembled into four (4) parts and “reply”, “delete”, “protect”, “edit” and “back” keys are displayed. The “back” key is the same as FIG. 6A. The “reply” key is a key selected when replying to the sender; the “delete” is a key selected when deleting that e-mail from the memory 36; the “protect” key is a key selected when protecting from being deleted by mistake; and the “edit” key is a key selected when saving the sender information and others into the memory 36. In this way, a layout of the operation keys displayed on the sub-screen can be freely changed. Also, a sub-menu assigned to each displayed operation key is not limited to the example in FIG. 6C.

In step S61, if an image is attached to the e-mail, the attached image may be displayed on the sub-screen 2 as sub-contents. Even in this case, since the attached image is displayed as a background to perform layered display of the status information on the attached image, it is possible to identify the status information.

Although omitted in FIG. 5, if an operation is not performed for predefined time in each step (S10, S20, S31, S41, S32, S42, S51 and S61), the portable telephone can make the transition to the power-saving mode which reduces the display contents for reducing electricity consumption.

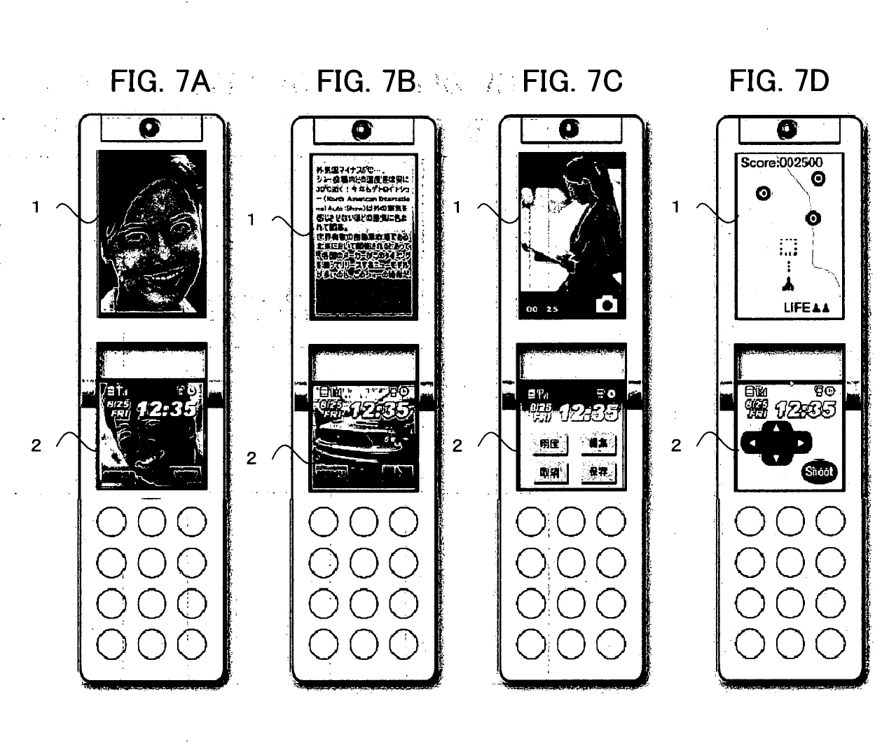

FIGS. 7A to 7D are diagrams describing specific examples of the sub-contents (the concomitant display), and FIG. 7A is an example at the time of using videophone. In FIG. 7A, an image shot by a terminal of the other calling party (face of the other party) is displayed on the main screen 1 as the contents, and an image shot by own terminal (face of oneself), the status information and the operation keys (see FIG. 2C, for example the cross-shaped key 15) are displayed on sub-screen 2 as the sub-contents. In this way, the face of the other party is projected on the full area of the main screen, and the display which is unnecessary for the contents is relocated to the sub-screen, and therefore the contents are very easily viewable. Also, it is possible to give the user a feeling of talking within very close range and enhance the sense of reality. Further, since the status information and the face of oneself are displayed in a layered style, the status information can be identified even if the face of oneself is displayed on the sub-screen.

FIG. 7B is an example at the time of viewing an e-mail. In FIG. 7B, body texts of the e-mail are displayed on the main screen 1 as the contents, and an image attached to the e-mail, the status information 14 and the operation keys (see FIG. 2C, for example the cross-shaped key 15) are displayed on sub-screen 2 as the sub-contents. In this way, the body texts of the e-mail are displayed on the full area of the main screen, and the contents are very easily viewable. Also, the body texts of the e-mail can be conveniently identified without scrolling the screen. Further, the attached image can be identified at the same time, and efficiency of the mail identification operation is improved. Further, since the status information and the attached image are displayed in a layered style, the status information can be identified even if the attached image is displayed on the sub-screen.

FIG. 7C is an example at the time of viewing a still image. In FIG. 7C, a still image is displayed on the main screen 1 as the contents, and the status information 14 and the operation keys (see FIG. 2C, for example the cross-shaped key 15) are displayed on sub-screen 2. In this way, the still image is displayed broadly using the main screen, and the user can easily view the still image. In FIG. 7C, a mark indicating a mode (mode indicating whether a still image or a moving image, or whether viewing or shooting), a display of the number of images and a time display are displayed in the lower zone of the main screen, but these pieces of information can be displayed on the sub-screen, of course. The status information can be still identified on the sub-screen in FIG. 7C.

FIG. 7D is an example at the time of playing a game. In FIG. 7D, game images are displayed on the main screen 1 as the contents, and the status information 14 and the operation keys (see FIG. 2C, for example the cross-shaped key 15) for operating the characters on the main screen are displayed on sub-screen 2. In this way, the game images are displayed on the full area of the main screen, and the contents are very easily viewable. The status information can be identified on the sub-screen. As the sub-contents associated with the game, for example, special effects, such as flashing the sub-screen when the characters are bombed, may be expressed together with the main screen.

According to the above present invention, the status information or the guidance information is not displayed on the first display unit (main screen) to enable effective utilization of whole screen, and a layout of the screen becomes more clear than the case that such information is displayed, and visibility is improved. The display area of the first display unit is further enlarged by displaying the concomitant display on the second display unit (sub-screen), which is displayed concomitantly to the display contents of the first display unit.

For example, in the case of using videophone, traditionally, an image shot by a terminal of the other calling party (face of the other party) and an image shot by own terminal (face of oneself) are displayed on one (1) screen, but by displaying the face of the other party on the main screen and the face of oneself on the sub-screen, it is possible to feel like talking face to face, and the sense of reality is enhanced. Also, by using the sub-screen for previewing an image file attached to an e-mail, the main screen can continue displaying the body text, and it is possible to read the body text while identifying the image file, without the display area of the body text being occupied by the attached image file. Therefore, a user can make the most of e-mails, Web contents, moving images, still images and others without being bothered by the status information and the guidance information.

Since the operation keys (see FIG. 2C, for example cross-shaped key 15) are displayed on the touch panel provided on the second display unit (sub-screen) depending on the display contents of the first display unit, a button layout is organized, and since the operation keys (see FIG. 2C, for example cross-shaped key 15) displayed on the sub-screen act as input means, it is not necessary to display the guidance information. Further, by watching the second display unit, the user can identify the status information. Even if the concomitant display is displayed on the second display unit, the status information is displayed in a layered style, so the status information can also be identified in this case.

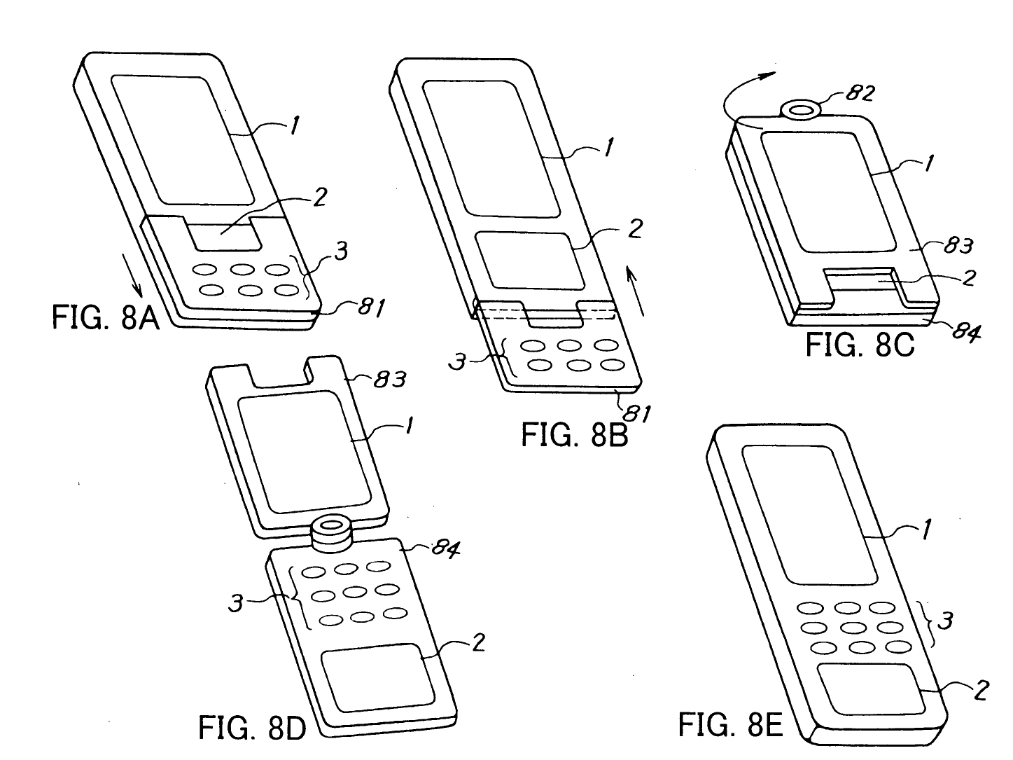

The present embodiment is described taking the folding-type portable telephone (including PHS) as an example, but the present invention can apply to the flip type shown in FIG. 1A and other portable telephones, such as the slide type (FIG. 8A and FIG. 8B) and the rotating type (FIG. 8C and FIG. 8D) which are shown in FIGS. 8A to FIG. 8E. In the slide-type portable telephone of FIG. 8A, the input buttons are disposed on a cover 81, and the sub-screen 2 is covered by the cover 81 except a portion. The status information 14 is displayed on the sub-screen 2 which can be visually recognized even when the cover 81 is closed. When the cover 81 is slid to a direction of an arrow of FIG. 8A, whole of the sub-screen 2 can be visually recognized (see FIG. 8B). The sub-screen 2 is the touch panel, and since the operation keys (see FIG. 2C, for example cross-shaped key 15) are displayed depending on the display contents of the main screen 1, the main screen 1 can be used to the greatest extent possible.

In the rotating-type portable telephone of FIG. 8C, a portion of a first housing 83 having the main screen 1 is notched, and a portion of the sub-screen 2 can be visually recognized through the notch. The status information 14 is displayed on the sub-screen 2 which can be visually recognized in the state of FIG. 8C. By rotating the first housing 83 to a direction of an arrow of FIG. 8C through a hinge 82, the terminal can be in an opened state as shown in FIG. 8D. In this state, whole of the sub-screen 2 can be visually recognized, and the hidden input buttons 3 covered by the first housing 83 are revealed. The sub-screen 2 is the touch panel, and since the operation keys (see FIG. 2C, for example cross-shaped key 15) are displayed depending on the display contents of the main screen 1, the main screen 1 can be used to the greatest extent possible.

It is needless to say that the present invention can be practiced even in the portable telephone (straight type, see FIG. 8E) without the flip (FIG. 1A) 4 or the cover 81. The straight-type portable telephone is the one of which the main screen 1, the sub-screen 2 and the operation buttons 3 are disposed on one (1) housing.

Therefore, in addition to the portable telephone shown in FIG. 1C and FIG. 1D, if the flip-type, the slide-type, the rotating-type and the straight-type portable telephones (including PHS) are used, the same advantages as the present invention can be obtained. It is possible to apply not only to the portable telephones but also to portable terminals represented by PDA, fixed telephones with liquid-crystal display units, facsimile apparatuses and other terminal apparatuses. In these cases, although various types such as the straight type, the flip type, the slide type, the rotating type and others may be conceivable for the terminal apparatuses, it is possible to apply to any type.

While illustrative and presently preferred embodiments of the present invention have been described in detail herein, it is to be understood that the inventive concepts may be otherwise variously embodied and employed and that the appended claims are intended to be construed to include such variations except insofar as Limited by the prior art.

1. A terminal apparatus comprising:
a first and a second display units; and
a control unit which controls display contents of the first and the second display units respectively, wherein
the control unit displays, on the second display unit, status information as well as an operation key associated with the display contents displayed on the first display unit and changes the display contents displayed on the first display unit in response to an input with the operation key.

2. The terminal apparatus according to claim 1, wherein
the status information displayed on the second display is visually recognizable as long as the power is on.

3. The terminal apparatus according to claim 1, wherein
if there is an concomitant display which is displayed concomitantly to the display contents, the control unit displays the concomitant display on the second display unit.

4. The terminal apparatus according to claim 1, wherein
the operation key is a touch panel.

5. The terminal apparatus according to claim 1, wherein
the status information includes any one selected from a group having a remaining level of a battery, an radio wave receiving condition, a date, an icon indicating a setting status of the manner mode, an icon indicating an alarm setting status, an icon indicating presence of unanswered incoming calls, an icon indicating presence of messages left on an answering machine and an icon indicative of being in the Internet connection status.

6. The terminal apparatus according to claim 2, wherein
the status information includes any one selected from a group having a remaining level of a battery, an radio wave receiving condition, a date, an icon indicating a setting status of the manner mode, an icon indicating an alarm setting status, an icon indicating presence of unanswered incoming calls, an icon indicating presence of messages left on an answering machine and an icon indicative of being in the Internet connection status.

7. The terminal apparatus according to claim 3, wherein
the status information includes any one selected from a group having a remaining level of a battery, an radio wave receiving condition, a date, an icon indicating a setting status of the manner mode, an icon indicating an alarm setting status, an icon indicating presence of unanswered incoming calls, an icon indicating presence of messages left on an answering machine and an icon indicative of being in the Internet connection status.

8. The terminal apparatus according to claim 1, further comprising
a joint unit for joining a first housing where the first display unit is disposed and a second housing where the second display is disposed each other, wherein
the first housing and the second housing is foldably joined together via the joint unit and the status information is displayed on the second display unit such that it can be visually recognized in a folded state.

9. The terminal apparatus according to claim 2, further comprising
a joint unit for joining a first housing where the first display unit is disposed and a second housing where the second display is disposed each other, wherein
the first housing and the second housing is foldably joined together via the joint unit and the status information is displayed on the second display unit such that it can be visually recognized in a folded state.

10. The terminal apparatus according to claim 3, further comprising
a joint unit for joining a first housing where the first display unit is disposed and a second housing where the second display is disposed each other, wherein
the first housing and the second housing is foldably joined together via the joint unit and the status information is displayed on the second display unit such that it can be visually recognized in a folded state.
